(19) United States
(12) Patent Application Publication
(10) Pub. No.: US 2012/0318748 A1
(43) Pub. Date: Dec. 20, 2012

(54) ELECTROCHLORINATION METHOD FOR ABOVE-GROUND SWIMMING POOLS

(75) Inventors: Richard Carlson, Euclid, OH (US); Kenneth L. Hardee, Middlefield, OH (US); Stephanie Ann Lau, Painesville, OH (US)

(73) Assignee: Industrie De Nora S.p.A., Milan (IT)

(21) Appl. No.: 13/601,345

(22) Filed: Aug. 31, 2012

Related U.S. Application Data
(63) Continuation of application No. PCT/EP2011/053235, filed on Mar. 3, 2011.
(60) Provisional application No. 61/310,448, filed on Mar. 4, 2010.

(51) Int. Cl. C02F 1/78; C02F 1/467; E04H 4/16

(52) U.S. Cl. 210/748.2; 210/167.11

(57) ABSTRACT

The invention relate to the addition of mixture of non-halide salts to the water of above-ground swimming pools to allow sterilisation by in-situ electrochlorination with a modest sodium chloride content. A limitation of sodium chloride concentration in above-ground pools is necessary to prevent corrosion of the relevant steel supporting structure. The salt mixture additive contains sodium bisulphate and other salts of low toxicity.

### CROSS-REFERENCE TO RELATED APPLICATION

This application is a continuation of PCT/EP2011/053235 filed Mar. 3, 2011, that claims the benefit of the priority date of U.S. Provisional Patent Application No. 61/310,448 filed Mar. 4, 2010, the contents of which are herein incorporated by reference in their entirety.

### FIELD OF THE INVENTION

The invention relates to water disinfection in the field of swimming pools, in particular to electrochlorination of above-ground swimming pool water containing low concentrations of sodium chloride.

### BACKGROUND OF THE INVENTION

Active chlorine is generally used in swimming pools as the primary agent for water disinfection. In-situ generation of active chlorine by means of electrochemical units, known in the art as electrochlorinators, is usually preferred as a cheap solution to provide a controlled amount of disinfecting agent. Electrochlorinators produce hypochlorite ion, hypochlorous acid and other active chlorine species at the anode by electrolysis of diluted sodium chloride brines. For this reason, a certain quantity of sodium chloride must be dissolved in the pool water subjected to electrolysis.

While it is normally recommended to operate electrochlorinators for in-ground pools with water having a chloride ion concentration of about 1.5 to 4 g/l, the water of above-ground pools must be generally kept at a lower chloride concentration, ranging around 0.25-0.5 g/l. The reason for keeping such a low chloride concentration is to prevent corrosion of the steel frames constituting the external supporting structure of above-ground or self-supporting pools, which are inevitably exposed to direct contact with pool water during use. Should chloride ion concentration sensibly exceed the threshold of 0.5 g/l, for instance reaching 1.5-3 g/l, severe corrosion phenomena would affect the steel frames leading to high associated costs. The use of special materials, more resistant to corrosion in a chloride environment, would be economically unviable due to the size of these structures.

However, such a low chloride content brings about some disadvantages. A first major drawback is that the electrical conductivity of the water is lowered, so that the operative voltage of electrochlorinators is substantially increased. The increase in the cell voltage not only implies a higher electrical energy consumption but also prevents the installation of bipolar-type electrolysers. Such electrolysers are comprised of a certain number of cells connected in electrical series. The number of individual cells making up the electrolyser is selected as a function of the size of the swimming pool and in the case of medium sized above-ground pools (e.g. 20,000 to 60,000 litres), it would lead to much higher overall voltage than acceptable in view of current safety norms and regulations. Conversely, monopolar-type electrolysers, wherein cells are electrically connected in parallel, are operated at a lower overall voltage, and involving a very high electrical current. This construction requires expensive rectifiers and connections and is generally not taken into consideration.

A second inconvenience is associated with the active chlorine generation rate of the electrolysers. This rate depends both on the electrical current fed to the electrolysers and on the chloride concentration, in its turn determining the mass transport of chloride ions to the electrode surface where they are converted to active chlorine. An exceedingly low chloride concentration reduces the associated mass transport, in its turn decreasing the rate of active chlorine generation and the current efficiency, part of the current being wasted to the undesired generation of by-product oxygen. The latter effect further increases the overall energy consumption of swimming pool water disinfection and sterilisation.

The above considerations show how it would be highly desirable to provide a swimming pool electrochlorination technology suitable for above-ground pools in terms of corrosion prevention and of energy consumption and efficiency.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter. As provided herein, the invention comprises, under one aspect a method of treatment of swimming pool water by in-situ generation of active chlorine by electrochloriating comprising the addition of the pool water with a mixture of non-halide salts prior to electrolysis enhancing the electrical conductivity and buffering the pH at a value of 7.0 to 8.0, wherein the water has a sodium chloride content of 0.25 g/l and the overall concentration of the mixture of non-halide salts after the addition is 1 to 2.5 g/l.

In a further aspect, the invention comprises an above-ground swimming pool comprising a supporting structure comprising a metal frame and an electrochlorinator fed with pool water, the pool water having a sodium chloride content of 0.25 g/l to 1 g/l and a non-halide salt content of 1 to 2.5 g/l.

To the accomplishment of the foregoing and related ends, the following description sets forth certain illustrative aspects and implementations. These are indicative of but a few of the various ways in which one or more aspects may be employed. Other aspects, advantages, and novel features of the disclosure will become apparent from the following detailed description.

Various aspects of the invention are set out in the accompanying claims. Under one aspect, a method of swimming pool water treatment by in-situ generation of active chlorine comprises the addition of pool water with a mixture of non-halide salts capable of enhancing the electrical conductivity and of buffering the pH in the range of 7.0 to 8.0 prior to electrolysis. In one embodiment, the pool water added with a mixture of non-halide salts has a sodium chloride concentration of 0.25 to 1 g/l, for instance 0.25 to 0.5 g/l. In one embodiment, non-halide salts are added to the pool water prior to electrolysis at an overall concentration of 1 to 2.5 g/l. The inventors have found that sodium bisulphate is a particularly suitable agent to enhance the conductivity of swimming pool water. In one embodiment, non-halide salts added to swimming pool water comprise sodium bisulphate and at least another species of negligible toxicity capable of establishing a pH, in one embodiment, in the range of about 7.0 to 8.0, and in another embodiment from about 7.3 to 7.8, which is an optimum range for human health protection in a chlorinated environment. In one embodiment, non-halide salts added to swimming pool water comprise sodium bisulphate and sodium bicarbonate in a weight ratio of 1 to 8, for instance of about 5. In another embodiment, non-halide salts added to swimming pool water comprise sodium bisulphate and sodium carbonate in a weight ratio of 2 to 10, for instance of about 8. In yet another embodiment, non-halide salts added to swimming pool water comprise sodium bisulphate and sodium sulphate in a weight ratio of 1 to 3, for instance of about 2.

Under another aspect, an above-ground swimming pool comprises a supporting structure comprising a metal frame, for instance a carbon steel frame, and an electrochlorinator fed with pool water, wherein the pool water has a sodium chloride content of 0.25 to 1 g/l and a non-halide salt content of 1 to 2.5 g/l. In one embodiment, the electrochlorinator of the above-ground swimming pool is a bipolar-type electrolyser. The non-halide salt content of the pool water can be made up of species capable of enhancing the electrical conductivity and buffering the pH in the range of 7.0 to 8.0, as mentioned above.

The addition of balanced salt mixtures to swimming pool waters containing low concentration of chlorides proved surprisingly effective in keeping cell voltages below the critical limit allowing the safe use of bipolar electrolysers as electrochlorinating units. In the practice, the requirement of anodically produced active chlorine, essentially consisting of a mixture of dissolved molecular chlorine gas, sodium hypochlorite and hypochlorous acid, can be satisfied by providing a suitably large anode surface. Such surface is commonly subdivided into a number of small individual anodes interleaved to cathodes of similar shape, installed in a cell body usually made of chemically resistant plastics. The cell body with its array of interleaved anodes and cathodes constitutes the electrolyser. Each couple of anodes and cathodes forms an individual cell. As already mentioned, individual cells arranged in a series connection represent the best solution to fit the characteristics of the cheaper rectifiers available on the market. Bipolar-type electrolysers are characterised by an overall operating voltage equal to the sum of individual cell voltages, or to the product of average cell voltage times the number of cells. The overall voltage must not exceed 30 volts according to the existing safety regulations. As a consequence, the individual cell voltage must also be lower than a critical limit, which is around 4 volts for electrolysers comprised of 5-8 cells. This number of cells is a typical value used for providing the active chlorine necessary to keeping the water of most swimming pools in fully sterilised conditions.

The following example is included to demonstrate particular embodiments of the invention. It should be appreciated by those of skill in the art that the techniques disclosed in the example which follows represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention. For example, while the addition of salt mixtures in sodium form is described throughout the application due to their low cost and high availability, it will be evident to a person of skill in the art that salts of similar cations, e.g. potassium salts, are suitable in many cases for achieving the same technical effect.

### EXAMPLE 1

A 6 cell electrolyser was constructed with bipolar configuration with electrodes in form of blades having a surface area of 100 cm² and a spacing of 3 mm. The cell was connected to a 500 gallon tank containing water with 0.5 g/l of sodium chloride. The water was continuously recirculated through the electrolyser to simulate an above-ground pool system. The electrodes were coated with a catalyst consisting of a mixed formulation of ruthenium and titanium oxides. An electrical current, ranging from 2.5 to 6 A per blade, was applied to the electrolyser. With a 5 A electrical load the total voltage of the electrolyser was about 40 V, largely above acceptable limits. The current efficiency, defined as the fraction of current effectively used for generating active chlorine, was about 60%, the balance being consumed for the undesired by-product oxygen generation. This production rate would be sufficient to maintain a typical above-ground pool.

Additional sodium chloride was then added to the tank to increase the concentration up to 3 g/l, according to the normal practice of in-ground swimming pools. The resultant increase in the electrical conductivity led to a decrease in cell voltage down to about 3.7 V, corresponding to an overall electrolyser voltage of about 22 V, a value well within the acceptable upper limit. The current efficiency was about 60-70%. The electrolyser was kept under long-term operation to simulate a pool season. Steel panels simulating the construction materials of an above-ground pool were suspended in the tank. At the end of the test, there were unmistakable signs of chloride-induced localised corrosion on the steel panels. Such corrosion would be detrimental to the long term structural integrity of an above-ground pool.

The tank was replenished with fresh water with 0.5 g/l sodium chloride and the electrolyser was operated in a similar long-term manner with fresh steel panels. At the end of an equivalent period of time, the steel panels exhibited significantly less corrosion than the previous test indicating no deleterious effect on the long term operation of an above-ground pool.

With the 0.5 g/l sodium chloride solution, the current load to the cell was reduced by 50% down to 2.5 A, corresponding to a current density of 2.5×10⁻² A/cm². The average individual cell voltage amounted to 4.9 V with an overall electrolyser voltage of about 30 V, just within acceptable limits. The current efficiency was only 30%. The most important consequence was the thoroughly decreased production rate of active chlorine resulting from the combination of a low current load with a reduced current efficiency, to the extent that two electrolysers would have been needed for complying with the active chlorine requirement of a pool. This condition was clearly unacceptable, so the test was terminated.

The test was then resumed after adding to the tank a mixture of non-halide salts, surprisingly achieving a decrease in cell voltage while having a more than reasonable production rate of active chlorine. The cell voltage decrease was made possible by an increase in the electrical conductivity of water, which was almost doubled after the salt addition. At an electrical load of 5 A, the cell voltage ranged around 3.6-3.8 V as shown in the Table I hereafter. With a bipolar electrolyser arrangement made of 6 to 8 cells, the overall voltage obtained is of 22 to 30 V, well within the safety limits. At the same time, the production rate of active chlorine was sufficient for securing a stable disinfection and sterilisation in spite of a modest 30% current efficiency due to the high current load, the active chlorine production rate being the product of current efficiency times the current load. Hence, even though the current efficiency was approximately the same as in the test with 0.5 g/l of NaCl, in this case the addition of the salt mixture allowed operating with an electrical load of 5 A without exceeding the safety limits in terms of electrolyser voltage.

In principle, several non-halide salts can be used as swimming pool water additives, provided they satisfy a few minimum requirements. In a first place, the added salts and their concentration must be compatible with human health and environmental norms and regulations. The inventors have found that a mixture of sodium bisulphate, NaHSO₄, and sodium bicarbonate, NaHCO₃, provides a satisfactory solution. These two salts, at an overall concentration around 1-2 g/l, for instance 1.5 g/l, not only increase the electrical conductivity to such an extent that reasonable voltages are obtained, but have the additional advantage of buffering the pH of the solution at optimum values as regards human health protection in a chlorinated environment. Such a pH range of 7.3 to 7.8 is established by virtue of the chemical equilibrium between the bisulphate (HSO4⁻) and the sulphate (SO₄⁼) species generated by the reaction with the bicarbonate ion, HCO3⁻. This pH range is particularly favourable in terms of disinfecting efficacy as it leads to a significant presence of hypochlorous acid (HClO), which is known to be the most efficient killer of many pathogenic microorganisms, at the same time being not aggressive to the human body. A large number of sodium bisulphate-sodium bicarbonate combinations were tried in a specific test campaign. While all combinations in a range of 1 to 8 were found to be useful, the inventors have found that a bisulphate to bicarbonate weight ratio of about 5 is an optimum choice. A few results of the test campaign are reported in the following Table I. In all of these tests, 40 mg/l of cyanuric acid were added to the water in order to protect the generated active chlorine species from UV radiation, as known in the art.

TABLE I

| | | | | | Active | Active | | |
|---|---|---|---|---|---|---|---|---|
| | | | Cell | | chlorine | chlorine | | |
| NaCl | NaHSO₄ | NaHCO₃ | voltage | Current | output | residual | | Temperature |
| g/l) | (g/l) | (g/l) | (V) | (A) | (g/h) | (mg/l) | H | (° C.) |
| 0.5 | 1160 | 230 | 3.6 | 5 | 13760 | 7.5 | .6 | 27 |
| 0.5 | 1280 | 240 | 3.6 | 6.5 | 8270 | 7.0 | .7 | 33 |
| 0.5 | 1120 | 280 | 3.8 | 5 | 9920 | 2.0 | .6 | 32 |

The inventors obtained similar results with other salt mixtures containing sodium bisulphate with either sodium carbonate or sodium sulphate. In such mixtures, optimum conditions were observed with weight ratios of 8:1 and 2:1 respectively. Also the single addition of sodium bisulphate was tested, with less satisfactory but still acceptable results.

In this case, a pH around 7.1 was established.

At the end of the test campaign, the steel panels were again inspected, showing only minor signs of corrosion.

The previous description shall not be intended as limiting the invention, which may be used according to different embodiments without departing from the scopes thereof, and whose extent is solely defined by the appended claims. Throughout the description and claims of the present application, the term “comprise” and variations thereof such as “comprising” and “comprises” are not intended to exclude the presence of other elements, components or additional process steps.

What we claim is:

1. Method of treatment of swimming pool water by in-situ generation of active chlorine by electrochloriating comprising the addition of the pool water with a mixture of non-halide salts prior to electrolysis enhancing the electrical conductivity and buffering the pH at a value of 7.0 to 8.0, wherein the water has a sodium chloride content of 0.25 g/l and the overall concentration of the mixture of non-halide salts after the addition is 1 to 2.5 g/l.

2. The method according to claim 1, wherein the mixture of non-halide salts comprises sodium bisulphate and sodium bicarbonate.

3. The method according to claim 2, wherein the sodium bisulphate and the sodium bicarbonate are added in a weight ratio of 1 to 8.

4. The method according to claim 1, wherein the mixture of non-halide salts comprises sodium bisulphate and sodium carbonate.

5. The method according to claim 4, wherein the sodium bisulphate and the sodium carbonate are added in a weight ratio of 2 to 10.

6. The method according to claim 1, wherein the mixture of non-halide salts comprises sodium bisulphate and sodium sulphate.

7. The method according to claim 6, wherein the sodium bisulphate and the sodium sulphate are added in a weight ratio of 1 to 3.

8. The method according to claim 1, wherein the pH value is buffered at a value of 7.3 to 7.8.

9. Above-ground swimming pool comprising a supporting structure comprising a metal frame and an electrochlorinator fed with pool water, the pool water having a sodium chloride content of 0.25 g/l to 1 g/l and a non-halide salt content of 1 to 2.5 g/l.

10. The swimming pool according to claim 9, wherein the electrochlorinator is a bipolar-type electrolyser.

11. The swimming pool according to claim 9, wherein the non-halide salt content comprises sodium bisulphate and sodium bicarbonate at a weight ration of 1 to 8.

12. The swimming pool according to claim 9, wherein the non-halide salt content comprises sodium bisulphate and sodium carbonate at a weight ratio of 2 to 10.

13. The swimming pool according to claim 9, wherein the non-halide salt content comprises sodium bisulphate and sodium sulphate at a weight ratio of 1 to 3.
